(19) United States
(12) Patent Application Publication
(10) Pub. No.: US 2021/0247074 A1
(43) Pub. Date: Aug. 12, 2021

(54) SENSOR ENABLED RANGE HOOD

(71) Applicant: Broan-NuTone LLC, Hartford, WI (US)

(72) Inventors: Richard R. Sinur, Hartford, WI (US); Brent Walter Lillesand, Hartford, WI (US); Bradley Joseph Mergener, Hartford, WI (US); Ryan Anthony Revers, Hartford, WI (US)

(21) Appl. No.: 17/268,363

(22) PCT Filed: Aug. 16, 2019
(86) PCT No.: PCT/US19/46805

§ 371 Date: Feb. 12, 2021

Related U.S. Application Data
(60) Provisional application No. 62/719,423, filed on Aug. 17, 2018.
(60) Provisional application No. 62/752,058, filed on Oct. 29, 2018.
(60) Provisional application No. 62/767,836, filed on Nov. 15, 2018.

(51) Int. Cl. F24C 15/20; A62C 3/00

(52) U.S. Cl. CPC F24C 15/2021; A62C 3/006

(57) ABSTRACT

A sensor-enabled hood for use over a cooking surface, where the hood includes a fire sensor module to provide improved monitoring of the cooking surface and related cooking conditions. A distance sensor assembly automatically determines the distance between the fire sensor module and the cooking surface for calibration of the fire sensor module. The fire sensor module can be operated with a monitoring and alerting algorithm to increase the accuracy of the fire sensor module's monitoring of the cooking surface, including the cooking conditions.

### CLAIM OF PRIORITY

This patent application claims the benefit of priority of PCT Patent Application Ser. No. PCT/US19/46805 filed Aug. 16, 2019; U.S. Provisional Patent Application Ser. Nos. 62/719,423 filed Aug. 17, 2018; 62/752,058 filed Oct. 29, 2018; and 62/767,836 filed Nov. 15, 2018, which are hereby incorporated by reference herein in its entirety.

### TECHNICAL FIELD

The present description relates, in general, to a sensor enabled range hood for use over a cooking surface, and more particularly to a sensor enabled range hood with an advanced sensor assembly to provide improved monitoring of the cooking surface and related cooking conditions.

### BACKGROUND

There currently are a few “stove guard” products in the marketplace that include at least one sensor and that are installed above a cooking surface, such as a cook top, burner (or collection of burners) or stove, located within a home or business, such as a restaurant. These stove guard products are designed to monitor an action or condition on the cooking surface, and then use output from the sensor to make various decisions and actions. The typical actions include warning a person of an “unattended cooking” situation or an elevated cook top temperature situation. In some cases, the conventional stove guard products provide an automatic shutoff of the fuel source to the cook top or stove prior to a fire event. These conventional stove guard products can be directly mounted to a wall location above the cook top, or mounted within a hood (e.g., a “range hood”) positioned above the cook top. Typically, these conventional products use simple infrared temperature sensors, thermistors, and current sensors to determine the state of the cooking surface, all of which have inherent limitations that impact the functionality and appeal of the conventional products.

Conventional stove guard products require the installer or end-user (e.g., homeowner) to determine and then manually set the sensor sensitivity level during installation of the stove guard product based upon the actual installed height of sensor. This process usually requires the installer or end-user to make accurate measures and carefully follow a chart in the installation instructions. The problem with this is that if the installer does not accurately understand, measure, and set the sensor's sensitivity level—the sensors and product's algorithm may provide erroneous results, such as a false positive alert/response, a delayed alert/response or no alert/response.

The systems disclosed below address some of the limitations associated with these conventional stove guard products, and also provides added functionality and benefits, including improved performance and value to consumers.

The description provided in the background section should not be assumed to be prior art merely because it is mentioned in or associated with the background section. The background section may include information that describes one or more aspects of the subject technology.

### SUMMARY

A sensor-enabled range hood is disclosed for positioning over a cooking surface, the sensor-enabled range hood comprising a hood body; a fire sensor module configured to be connected to the hood body; a distance sensor assembly in communication with the fire sensor module, the distance sensor assembly configured to determine a critical distance between the hood body and the cooking surface; wherein the critical distance facilitates accurate monitoring of the cooking surface by the fire sensor module. The critical distance is continually monitored by the distance sensor assembly to identify obstructions placed on the cooking surface, or other changes on the cooking surface that may impact the accuracy of monitoring the cooking surface. The distance sensor can be positioned within the hood body. The fire sensor module can be positioned within the hood body. The distance sensor assembly and the fire sensor module can be configured to be different distances from the cooking surface. The fire sensor module and the distance sensor assembly can be in a single package. The fire sensor module can be operated in association with a monitoring and alerting algorithm and the critical distance can used by the monitoring and alerting algorithm to increase accuracy of the monitoring of the cooking surface by the fire sensor module. The monitoring and alerting algorithm can be resident on the fire sensor module. The monitoring and alerting algorithm can be resident on the cloud. The distance sensor assembly can be a laser-ranging sensor module.

A sensor-enabled hood system is also disclosed comprising a hood body; a fire-senor module configured to be associated with the hood body; a distance sensor assembly configured to be in communication with the fire-sensor module, the distance sensor assembly capable of determining a critical distance between the hood body and an associated cooking surface. The distance sensor assembly can be a laser-ranging sensor module. A sensitivity level of the fire-sensor module can be configured to be adjusted according to the critical distance. The fire-sensor module can be configured to be calibrated according to the critical distance. The fire sensor module and the distance sensor assembly can be in a single package.

A sensor system for a range hood is also disclosed, the sensor system comprising a fire-sensor module; a distance sensor assembly configured to be in communication with the fire-sensor module, the distance sensor assembly capable of determining a critical distance between the distance sensor assembly and an associated cooking surface. The distance sensor assembly can be a laser-ranging sensor module. A sensitivity level of the fire-sensor module can be configured to be adjusted according to the critical distance factor. The fire-sensor module can be configured to be calibrated according to the critical distance factor. The fire sensor module and the distance sensor assembly can be in a single package.

A method is also disclosed, the method comprising the steps of: (i) providing a fire-sensor module; (ii) providing a distance sensor assembly configured to be in communication with the fire-sensor module; (iii) determining a critical distance between the distance sensor assembly and an associated surface; and (iv) providing the critical distance to the fire-sensor module.

### BRIEF DESCRIPTION OF THE DRAWINGS

The technology will now be described, by way of example, with reference to the accompanying drawings in which:

FIG. 1 is an illustration showing examples of various sensors or controls that can be used in or with the present sensor-enabled range hood system or method.

FIG. 2 is an illustration showing examples of a tiered condition determination or response.

FIG. 3 is an illustration showing an example of portions of a sensor-enabled range hood system.

FIG. 4 is an illustration showing an example of a tiered condition determination or response technique, such as can be performed using a sensor-enabled range hood system, such as that shown in FIG. 3.

FIG. 5 is a front view of a range hood showing the hood installed above a cooking surface of a cook top that is monitored by a sensor assembly and a fire sensor module.

FIG. 6 is a front perspective view of the range hood and cooking surface of FIG. 5 with illustrations showing measurement activity by the distance sensor assembly.

FIG. 7 a flow chart provided steps for using the critical distance identified by the distance sensor assembly to improve the performance of the fire sensor module of FIG. 5.

FIGS. 8A-8B provide a flow chart showing different steps for using the critical distance to improve the performance of the fire sensor module.

In one or more implementations, not all of the depicted components or steps in each figure may be required, and one or more implementations may include additional components or steps not shown in a figure. Variations in the arrangement and type of the components may be made without departing from the scope of the subject disclosure. Additional components or steps, difference components or steps, or fewer components or steps may be utilized within the scope of the subject disclosures.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

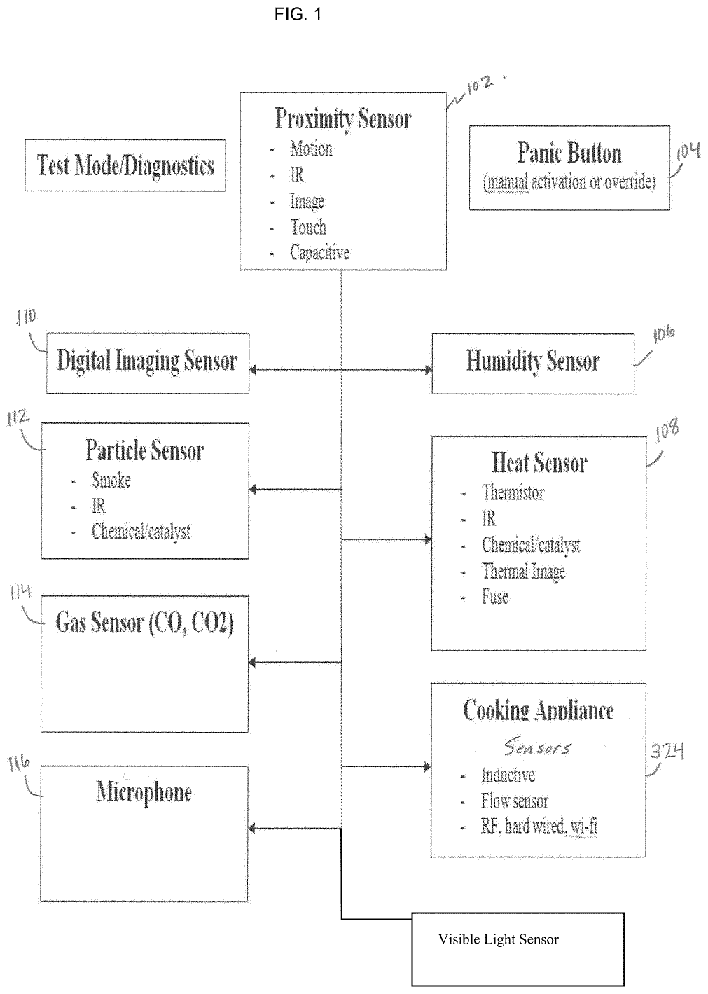

In an example, the systems and methods can include one or more components that can be located, or steps that can be performed, in or near a cooking area, such as in a kitchen. For example, one or more sensors in one or more sensor configurations (e.g., such as shown in FIG. 1) can form part of a sensor-enabled range hood system, such as by being included in the range hood, a cooking appliance, or elsewhere. The sensor-enabled range hood system can include or can be used with a range system that can include, for example, a gas range system, an electric range system, a halogen range system, an inductive range system, an infra-red range system, a microwave range system, or a combination range system (e.g., a range system that can use any one or combination of the foregoing range systems). Further, one or more of the components described herein can be integrated into an over-the-range hood, such as an over-the-range microwave hood (e.g., an over-the-range microwave oven including an over-the-range exhaust hood).

During operation, for example, when the sensor-enabled range top features multiple cooking surfaces, or during multiple sequential or prolonged cooking episodes, or when cooking certain types of foods, the sensor-enabled range hood may be exposed to high temperatures. The sensor-enabled range hood outer surface and internal components may be heated such as by convection, infra-red heat, or from steam, hot gases and cooking effluent, or may be operated in an environment with a high ambient temperature. In some instances, the sensor-enabled range hood outer surface or internal components may be heated by a fire or over-heated food on one or more cooking surfaces of the sensor-enabled range top. In some circumstances, the sensor-enabled range hood outer surface or internal components may be heated by a fire from a foreign material or object on one or more cooking surfaces of the sensor-enabled range top (for example, a cooking utensil, wash-cloth, clothing, plastic food container, or other material).

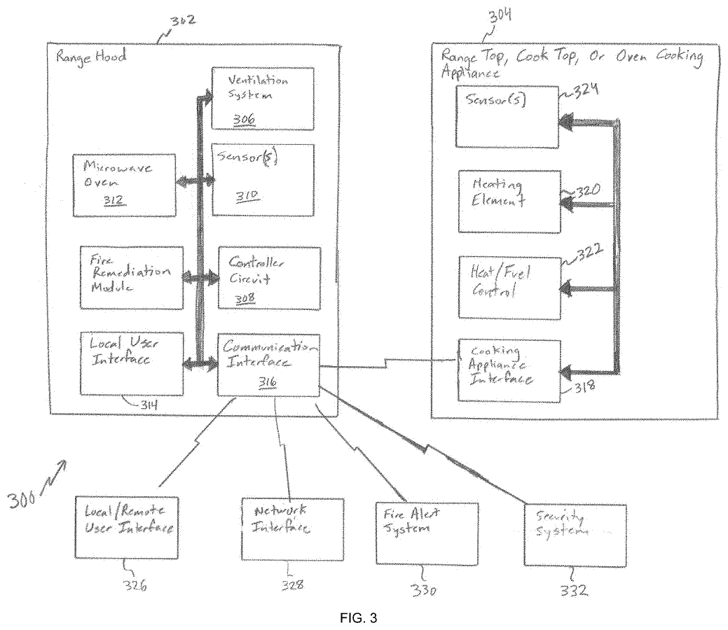

The sensors and sensor configurations shown in FIG. 1 can form part of a sensor-enabled range hood system 300, an example of which is shown in FIG. 3. The sensor-enabled range hood system can include or be coupled to at least one control system. In an example, one or more of the sensors or sensor control components can be located immediately adjacent to, within, or above a cooktop or range top. Accordingly, although the description herein includes examples of components of the sensor-enabled range hood system installed within a region of a kitchen, this description is not intended to limit the scope of this disclosure to kitchen or cooking-related applications.

In an example, the sensor-enabled range hood system can include at least one proximity or occupancy sensor 102, such as can be used to detect the presence or absence of a user, such as at or near the range or at or near the kitchen, and a visible light sensor 103 to detect the ambient light intensity and/or color temperature, typically measured in Kelvin (K). The at least one proximity sensor 102 can also include a motion sensor. In an example, the proximity sensor 102 can include an infra-red radiation sensor, such as can be configured to detect infra-red radiation emitted by a user. In an example, the infra-red radiation sensor can additionally or alternatively be configured to detect one or more levels of infra-red radiation emitted and/or reflected by a cooking element or a cooking utensil, or emitted and/or reflected from an enclosed or other cooking region of the sensor-enabled range hood system (for example, within an oven). In an example, the infra-red radiation sensor can additionally or alternatively be configured to detect infra-red radiation emitted and/or reflected from a range top cooking surface, configured to detect the presence or absence of an object such as a cooking utensil on a the range top surface, the infra-red profile or temperature of the cooking surface or utensil, or the presence or absence of an ignition source or a material about to ignite, igniting, or undergoing combustion.

In an example, the one or more proximity sensors 102 can include an image sensor, such as for example a photo-diode array or a charge-coupled device, or other digital imaging sensor 110. For example, the image sensor can be configured to image a user (e.g., to allow the control system to determine the presence or absence of a user, such as in or near a specified space). The image sensor can additionally or alternatively be configured to image a cooking element or a cooking utensil. For example, an image sensor can be configured to image an enclosed cooking region of the sensor-enabled range hood system (for example, a region of an oven). The image sensor can additionally or alternatively be configured to detect a range top cooking surface, such as to detect one or more of the presence or absence of an object such as a cooking utensil on a the range top surface, the infra-red profile or temperature of the cooking surface or utensil (e.g., if the image sensor is sensitive to infra-red wavelengths), or the presence or absence of an ignition source or a material about to ignite, igniting, or undergoing combustion). In an example, the image sensor can be configured to detect a material undergoing an exothermic reaction, such as one or more of pre-ignition, ignition, or combustion. In yet another example, the image sensor can be configured to warn a user of a potential burn risk caused by a high temperate on the range top surface or a high temperature of a cooking utensil (e.g., pot, pan, spoon) placed on the range top surface. The image sensor can be programmed to provide an audible warning and/or visual warning of the high temperature condition to the user, for example, providing a warning to “Use Oven Mitt, Cooking Utensil Too Hot to Handle.”

In an example, the system's proximity sensor can include a touch or capacitive sensor. The touch or capacitive sensor can be configured as a proximity sensor, such as to detect a user, or can additionally or alternatively be configured to detect a cooking utensil. In an example, a touch or capacitive sensor can be configured to detect the presence or absence of an object, such as a cooking utensil on a range top surface. In another example, the proximity sensor is incorporated into a portable device, such as a mobile telephone, or into a wearable device, such as a smartwatch with apps and connectivity functionality.

In an example, one or more proximity sensors can additionally or alternatively be configured for one or more other purposes, such as to detect the presence or absence of an object such as on or within the vicinity of one or more cooking elements such as within the sensor-enabled range hood system. For example, one or more proximity sensors can be configured to detect the presence or absence of an object such as a cooking utensil (for instance, a cooking pot or a frying pan, etc.). In some embodiments, one or more proximity sensors can be used to detect the presence or absence of an object, such as a cooking utensil, such as on a range top cooking surface. In an example, one or more proximity sensors can be used to detect the presence or absence of an object, such as a cooking utensil, such as within an enclosed cooking region of or adjacent the sensor-enabled range hood system (for example, within an oven).

In an example, the sensor-enabled range hood system can include at least one panic button 104. The panic button can include manual activation or override of at least one function of the sensor-enabled range hood system. In an example, a user can tum off at least one heating element of the sensor-enabled range hood system, such as by activating the panic button. In an example, a user can additionally or alternatively turn on or turn off at least one audible alarm of the sensor-enabled range hood system such as by activating the panic button. In an example, the system can include a panic button such as can be configured to turn on one or more local or remote elements of a fire alarm or fire suppression system.

The sensor-enabled range hood system can include at least one particulate sensor (“particle sensor”) 112, such as an ultrasound, particle image velocimetry, and/or fluorescence particulate sensors. The particulate sensor can be configured to detect a particulate cloud, such as smoke or other particulate material such that emitted from a material igniting or undergoing oxidative combustion. In an example, a particulate sensor can be configured to detect a particulate cloud, such as smoke or other particulate material such as that emitted from a material undergoing non-oxidative combustion or pyrolysis. The particulate sensor can include a digital imaging sensor such as can be configured to detect a particulate cloud by imaging and by image analysis, such as within a control system of the sensor-enabled range hood system. As mentioned previously, an infra-red sensor can also be included. In an example, the infra-red sensor can additionally or alternatively be configured to detect a particulate cloud, such as smoke or other particulate material emitted from a material undergoing oxidative combustion, non-oxidative combustion, or pyrolysis, or to distinguish or help distinguish between these sources of the particulate cloud.

In an example, the particulate sensor can include at least one chemical sensor, such as can be configured for detecting at least one or more products of oxidative combustion, one or more products of non-oxidative combustion, or one or more products of pyrolytic decomposition, or to distinguish or help distinguish between these. In an example, the particulate sensor can additionally or alternatively include one or a plurality of chemical sensors that can be located or distributed within the sensor-enabled range hood system. In an example, a plurality of chemical sensors can be configured to detect the same chemical species or to detect a different chemical species. In an example, the one or more chemical sensors can include a gas sensor 114 that can be configured to detect at least one non-flammable gas, such as a specified at least one of carbon monoxide, carbon dioxide, or one or more mixtures thereof.

In an example, the at least one chemical sensor can be configured to be capable of detecting a specified at least one of an oil or grease oxidative degradation product, an oil or grease non-oxidative degradation product, an oil or grease pyrolysis product, or an oil or grease vapor or fluid, or one or more mixtures thereof.

In an example, the at least one chemical sensor can be configured to be capable of detecting a specified at least one of a carbohydrate oxidative degradation product, a carbohydrate non-oxidative degradation product, or a carbohydrate pyrolysis product, or one or more mixtures thereof.

In an example, the sensor-enabled range hood system can include at least one chemical sensor that can be configured to be capable of detecting a specified at least one of a protein oxidative degradation product, a protein non-oxidative degradation product, or a protein pyrolysis product, or one or more mixtures thereof.

In an example, the sensor-enabled range hood system can include at least one chemical sensor that can be configured to be capable of detecting degradation of a cellulosic based material (for example, from a clothing or kitchen cloth or towel product). For example, the sensor-enabled range hood system can include at least one chemical sensor that can be configured to be capable of detecting a specified at least one of a cellulose oxidative degradation product, a cellulose non-oxidative degradation product, or a cellulose pyrolysis product, or one or more mixtures thereof.

In an example, the sensor-enabled range hood system can include at least one chemical sensor that can be configured to be capable of detecting degradation of a polymeric product (for example, a plastic utensil or kitchen container, or some portion of the housing of the sensor-enabled range hood system). For example, the sensor-enabled range hood system can include at least one chemical sensor that can be configured to be capable of detecting a oxidative degradation product such as from at least one of a nylon, a polyurethane, a polyethylene, a polypropylene, a polycarbonate, a polyester, or one or more copolymers or mixtures thereof. In an example, the sensor-enabled range hood system can include at least one chemical sensor that can be configured to be capable of detecting a detecting a non-oxidative degradation product such as from at least one of a nylon, a polyurethane, a polyethylene, a polypropylene, a polycarbonate, a polyester, or one or more copolymers or mixtures thereof. In an example, the sensor-enabled range hood system can include at least one chemical sensor that can be configured to be capable of detecting a pyrolysis product such as from at least one of a nylon, a polyurethane, a polyethylene, a polypropylene, a polycarbonate, a polyester, or copolymers or mixtures thereof.

In an example, the at least one chemical sensor can include a catalyst. For example, the sensor-enabled range hood system can include at least one sensor that can be configured to be capable of detecting a specified one or more products of oxidative combustion, non-oxidative combustion, or pyrolytic decomposition, such as described above, such as by catalytically converting at least one or more products and detecting the converted by-product.

The sensor-enabled range hood system can additionally or alternatively include at least one sound sensor (for instance, a microphone 116). In an example, the sound sensor can be configured to detect or distinguish at least the background noise from the vicinity of the sensor-enabled range hood system. In an example, the sound sensor can be configured to detect or distinguish a user or a background noise. In an example, the sound sensor can be configured to detect or distinguish sound emitted during at least one of a fire, a non-oxidative combustion, or a pyrolytic event. In an example, the sensor-enabled range hood system can include at least one microphone-enabled override of at least one function of the sensor-enabled range hood system. In an example, a user can update, modify, or otherwise control at least one control of the sensor-enabled range hood system such as including through a verbal command. In an example, the system can be configured such that a user can tum off at least one heating element of the sensor-enabled range hood system including by announcing a designated command that is capable of being received by the microphone-enabled override.

The sensor-enabled range hood system can additionally or alternatively include at least one humidity sensor 106. In an example, the at least one humidity sensor can be configured to be capable of detecting or distinguishing water vapor or steam. In an example, the humidity sensor can be configured to detect a change in humidity within the vicinity of the sensor-enabled range hood system. In an example, the humidity sensor can be configured to detect a change in humidity such as that produced as a result of a cooking event. In an example, the humidity sensor can be configured to detect a change in humidity such as that produced as a result of a combustion event, such as a fire.

The sensor-enabled range hood system can additionally or alternatively include at least one heat sensor 108. In an example, the heat sensor can be configured to detect a change in temperature, such as within the vicinity of the sensor-enabled range hood system. In an example, the heat sensor can be configured to detect a change in temperature such as that that can be produced as a result of a cooking event. In an example, the heat sensor can be configured to detect a change in temperature such as that can be produced as a result of a combustion event, such as a fire. In an example, the heat sensor can include a thermistor. As described herein, the heat sensor can include an infra-red sensor of the sensor-enabled range hood system. In an example, the infra-red sensor can include an imaging device, such as described herein. In an example, the heat sensor can comprise a thermally sensitive fuse. In an example, the heat sensor can include a heat sensitive catalyst such as can be configured to produce a sensor-detectable by-product when heated by at least one heat source.

The sensor-enabled range hood system can additionally or alternatively include at least one inductive sensor. For example, the sensor-enabled range hood system can include at least one inductive sensor that can be configured to detect the presence of a cooking utensil. In an example, the inductive sensor can be configured to sense current flowing in at least one inductive heating coil such as can be included in the range top or cooking top.

The sensor-enabled range hood system can include one or more cooking appliance sensors 324, such as a flow sensor, for example, such as can be configured to monitor and optionally control the flow of a combustible gas (for example, the flow of natural gas supplied to at least one cooking element of the sensor-enabled range hood system). In an example, the sensor-enabled range hood system can include a flow sensor that can be configured to monitor the fluid flow through at least one portion of the ventilation system of the sensor-enabled range hood system. In an example, a flow sensor can be included within at least one duct in or coupled to the ventilation system. In an example, the sensor-enabled range hood system can include a flow sensor that can be configured to detect a low flow rate of at least one portion of the ventilation system (for example, due to a blockage or malfunction of the ventilation system.

In an example, such as in order to exhaust at least a portion of a cooking effluent or one or more other fluids produced during a cooking episode, a ventilation assembly can be automatically or manually activated, such as to remove steam, or one or more other gases or one or more odors such as from the cooking area above the range top or one or more areas immediately adjacent to the range top. In an example, the sensor-enabled range hood system can include a ventilation system, which can include a fan and filter system that can be coupled within a housing that can include at least one inlet. The ventilation system can additionally or alternatively include a louver system, such as can be coupled to the fan, and a ducting system, such as can be coupled to the housing. In an example, at least a portion of a gaseous fluid can be moved away from the range top and immediately adjacent areas and pulled through the ventilation system such as via one or more fluid inlets of the ventilation system. The ventilation system can include one or more filters, such as can be located substantially in the ducting system, which can be coupled to the fan. In an example, the ventilation system can include at least one duct (e.g., including at least one fluid outlet) that can be coupled to a location external to the sensor-enabled range hood, such that can direct the exhausted effluent to a desired location (e.g., out of the structure, out of the local environment, or back out of the sensor-enabled range hood following filtration to remove odors and/or particulates, etc.).

In an example, the housing can include a filter interface, which can include or be coupled to a filter change or filtering monitoring system. For example, the housing can include a replaceable filter and at least one system or method for changing the elapsed time since filter install, filter use time since filter install, filter condition indicator, or a combination of one or more of these. In an example, a mechanical indicator can be included and can be configured to alert a user to the need to change one or more filters in the housing. In an example, the filter change indication can be based at least in part on the air flow rate through at least some portion of the ventilation system. In an example, the control system can be configured such that, as the filter becomes clogged over time, the control system can detect the reduction in flow rate through the ventilation system, such as using the flow sensor, which can be coupled to the control system. In an example, the filter system can include an onboard power source, which can be coupled with at least one of a timer circuit or at least one flow control sensor, or both. For example, the filter assembly can include an integrated filter life assembly, such as can include a printed circuit or a battery, such as a standard battery, rechargeable battery, piezoelectric battery or a printed battery. For example, the battery can provide a source of power, such as to a self-contained filter life-time assembly. In an example, the self-contained filter life-time assembly can include an electronic or chemical sensor and control circuitry. In an example, the ventilation assembly can alert a user to a time to replace the filter including the self-contained filter life assembly. In an example, the ventilation assembly can alert a user to a time to replace the filter, e.g., including the self-contained filter life assembly, such as via the controller and user-interface and such as based at least in part on a signal from the electronic or chemical sensor.

The sensor enabled range hood system can additionally or alternatively include a performance management system. In an example, a “before” and “after” indication can be displayed to a user, such as via a graphical or other user interface, as an example of an indicator that can show overall effectiveness of a ventilation event. In an example, the performance management system can be configured to display one or more of various parameters such as can be associated with the cooking episode, including but not limited to, the volume of air extracted, the temperature or humidity levels such as before and after the cooking episode, or an indication of the air quality (e.g., particulate, CO, CO2, hydrocarbons, etc.) before, during, and after the ventilation event.

The housing of the sensor-enabled range hood system can additionally or alternatively include a thermal capture system. For example, some of the heat captured and ordinarily vented from the cooking environment can be at least partially captured by the range hood such as for use to heat the room or space in which the sensor enabled range hood system is located. For example, the ventilation system can include at least one heat exchange assembly. During a cooking episode, heat can be extracted from exhausted effluent and can be passed back into the cooking environment, such as in the form of heated air. In an example, the air can be extracted from the cooking environment and heated, or extracted from an area outside of the cooking area, heated by the outgoing effluent, and then directed into the cooking environment or elsewhere. In an example, moisture can additionally or alternatively be captured from the cooking environment and returned to the cooking environment or directed elsewhere. For example, the housing of the sensor enabled range hood system can include a moisture capture system. In an example, at least some of the moisture ordinarily vented from the cooking environment can be at least partially captured by the range hood, such as can be used to increase the humidity at a desired location, such as the humidity of the room or space in which the sensor enabled range hood system is located. In an example, the ventilation system can include at least one moisture capture and exchange assembly. For example, during a cooking episode, moisture can be extracted from an exhausted effluent, and directed to a desired location, for example, passed back into the cooking environment, such as in the form of moist air. In an example, air extracted from the cooking environment can be used to feed moisture into the cooking environment. In an example, air can be extracted from an area outside of the cooking area, and moisture can be captured such as via the outgoing effluent, and the moisture can be directed toward a desired location, such as by being directed into the cooking environment. In an example, moisture release can be passive, and need not involve forced air. For example, the system can include a moisture capture and exchange assembly that can include one or more moisture exchange media, such as to retain moisture, e.g., from cooking, and to slowly release the moisture back into the room over time. For example, the moisture exchange media can include a desiccant (or similar or other wicking or absorbing material), such as to retain moisture from cooking and then slowly release the moisture back into the room over time.

The sensor-enabled range hood system can include a dynamic air flow management system. For example, the ventilation flow rate or the air flow from an area of the cooktop can be modulated, such as using information from one or more of the various sensors described herein. For example, the dynamic air flow management can be configured to produce an air flow pattern that can be adjusted, such as based at least in part on the specific cookware and placement on the range top or cooktop, such as can be determined using information from one or more of the sensors as described herein.

In an example, the ventilation assembly can be activated (e g , manually or automatically) such as to generate a fluid flow, such as to exhaust cooking effluent or one or more other gaseous or similar fluids. For example, the ventilation assembly can be configured to generate fluid flow from the inlet (e.g., leading to fluid entering the fluid path) through one or more portions of the ventilation system (e.g., the fluid box). The ventilation system can include one or more fluid outlets, such that at least a portion of the fluid can selectively exit the ventilation system via the one or more fluid outlets based, at least in part, on the sensor reading. For example, one or more of the fluid outlets can be configured to be in fluid communication with a ventilation network of the structure into which the ventilation system is installed, or can be directly coupled to an exhaust that can direct the exhausted effluent to a desired location (e.g., out of structure, out of the local environment, through a toe-kick of the counter, etc.). Moreover, the ventilation system can additionally or alternatively include one or more filters that can be located along the fluid path, such as to remove at least some portion of the effluent that may be desirous not to exhaust through one or more of the fluid outlets.

The sensor-enabled range hood system can additionally or alternatively include at least one ventilation outlet that can be connected to at least one duct of the sensor-enabled range hood system. The sensor-enabled range hood system can include one or more of: a fan, such as can be mounted or otherwise located within a housing of the sensor-enabled range hood system; a louver system, such as can be coupled to the housing or the fan or both; or a ducting system, such as can be coupled to the housing, the louver system, and the fan. In an example, the system can include or be coupled to a controller that can be configured for controlling a fan motor, such as to remove one or more of steam, one or more gases, or one or more odors, such as via the ducting at a specified rate. In an example, the sensor-enabled range hood system can include one or more components that can include one or more apertures, such as can be configured to provide an aesthetic appearance to the sensor-enabled range hood system. In an example, the one or more apertures can additionally or alternatively provide a fluid connection, such as between the exterior of the sensor-enabled range hood system and at least one internal component of the sensor-enabled range hood system. In an example, one or more of the apertures can be configured so as to fluidly connect the exterior of the sensor-enabled range hood system to internal ducting that can be arranged or otherwise configured to provide a fluid relief pathway. In an example, one or more of the apertures can be arranged or configured such as to fluidly connect the exterior of the sensor-enabled range hood system and at least one internal component of the sensor-enabled range hood system, such as to allow air cooling of one or more components.

The sensor-enabled range hood system can include at least one user interface. In an example, the sensor-enabled range hood system can include at least one user interface that can be coupled to at least one cooking element that is capable of being controlled by a user. For example, the sensor-enabled range hood system can include a housing that can include a graphical or other user interface. The at least one user interface can include one or more switches, buttons, or other control features. In an example, the switches, buttons, or other control features can be configured to provide the user with the ability to control a ventilation assembly (for example to control activation and deactivation or to select one or more of multiple available operational speeds of the ventilation assembly). In an example, the user interface can be configured to provide information or feedback to the user, such as including regarding some aspect of the operational status of the sensor-enabled range hood system. For example, a visual or audio indication can be emitted from a hood of the sensor-enabled range hood system to advise of activated heating elements in the cooking surface and the temperature levels of those activated heating elements. In an example, the visual indication can be provided through one or more displays (for instance an LCD display) or via one or more indicator lamps. The user interface can include one or more icons, such as can be associated with one or more switches or one or more other user controls, or one or more sensors or sensor control systems. In an example, the one or more icons associated with the one or more switches or other user controls on the user interface can be substantially similar or the same. In an example, the one or more icons associated with the one or more switches or other user controls on the user interface can be substantially different.

In an example, the sensor-enabled range hood system can include at least one user interface that can be configured to include a wireless or wired communication interface, such as can be coupled to an internet or wireless signal such as an RF network. For example, the sensor-enabled range hood system can include at least one wireless transceiver that can be configured to be capable of transmitting at least one signal and receiving at least one signal wirelessly, such as over an internet or other RF network. In an example, the system can be configured such that a user can monitor at least one function of the sensor-enabled range hood system remotely, such as via the wireless transceiver. In an example, a user can monitor at least one function of the sensor-enabled range hood system via the internet or via a cellular phone link. In an example, a user can monitor at least one function of the sensor-enabled range hood system via at least one of a computer, a laptop device, a tablet device, a cellular or other mobile phone, or a smart phone. In an example, a user can control at least one function of the sensor-enabled range hood system via at least one of a computer, a laptop, a tablet, a cellular phone or a smart phone. In an example, the sensor-enabled range hood system can additionally or alternatively be hard-wired to a network, such as an internet, such as via a local-area-network. The sensor-enabled range hood system can additionally or alternatively be coupled to a network, such as an internet, such as via a cable or telephone line. In an example, the system can be configured to enable a user to receive a sensor signal or an alarm remotely (e.g., via a wired or wireless network, such as an internet). In an example, the system can be configured to permit a user to control at least one alarm of the sensor-enabled range hood system remotely (e.g., via a wired or wireless network, such as an internet).

The sensor-enabled range hood system, can include a test or a diagnostics function, for example, a sensor test or a sensor diagnostics function, which can be remotely accessible, such as via an internet or a wireless or RF network).

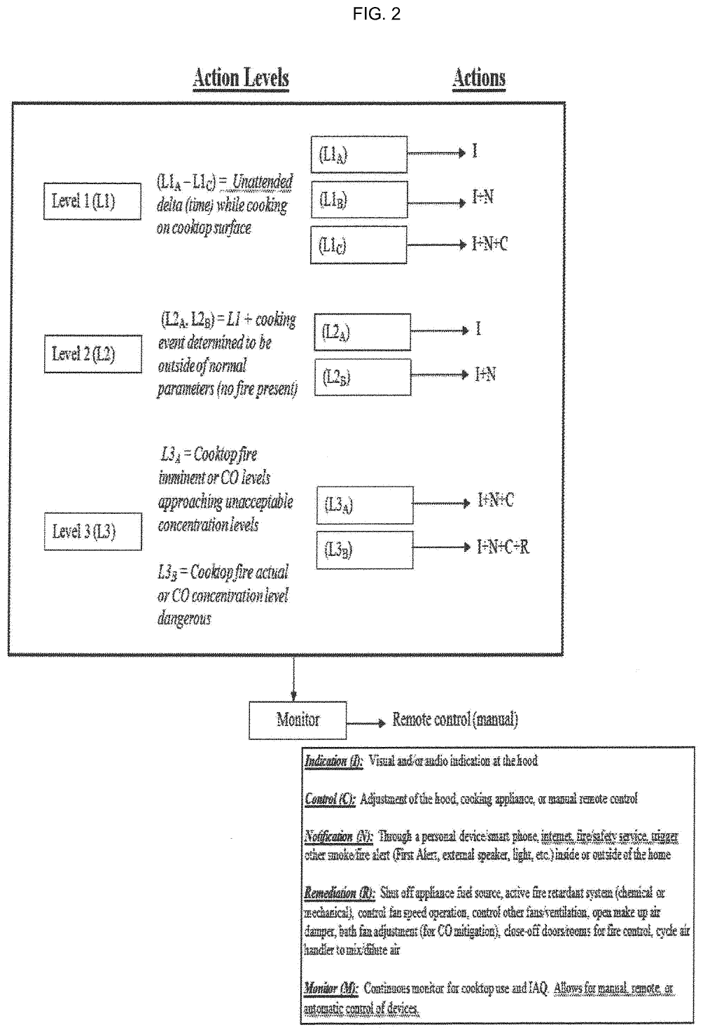

The sensor-enabled range hood system can include at least one control system that can be coupled to at least one sensor. The at least one control system can be configured to be capable of processing at least one sensor signal and performing at least one action based on information from or about the at least one sensor signal. FIG. 2 illustrates an example of action levels and actions of a sensor-enabled range hood sensor system. As shown, the sensor-enabled range hood system can include a plurality of action levels, a plurality of actions, or both. For example, the actions can include “Indication (I)”, “Control (C)”, “Remediation (R)”, and “Monitor (M)”. An example of the descriptions of the actions is provided below, which can be described as follows with respect to a plurality of action levels.

In an example, the action levels and actions can be controlled by a control system. For example, the plurality of action levels can include a level 1 (“L1”), a level 2 (“L2”) and a level 3 (“L3”). One or more of the levels L1, L2, or L3 can include one or a plurality of actions, with each of one or the plurality of actions triggered by one or more level criteria. In an example, an L1 criteria can include unattended delta (time) while cooking on cooktop surface. For example, one or more sensors, such as the digital imaging or other proximity sensors described herein, can be used to determine the presence of a user nearby the cooktop surface, with the controller circuit including a timer circuit that can be configured to measure an elapsed time since the user was last declared present by controller circuit analysis of signal information from the one or more proximity sensors. This elapsed time can be compared to an unattended time threshold value, which can serve as at least one of the L1 criteria.

In an example, one or more L2 criteria can additionally or alternatively be included. For example, the L2 criteria can include an L1 criteria plus conjunctively requiring an indication that a cooking event is determined to be outside of normal parameters (but no fire is present). In an example, based on whether at least one of the level criteria, such as described herein, is met, the sensor-enabled range hood system, controlled by the at least one control system, can initiate at least one action.

In an example, an L1 action can include an “L1_{A}” action. In an example, the L1_{A} action can include the controller circuit triggering a visual or audio indication at the sensor-enabled range hood system, such as at the user interface. In an example, the sensor-enabled range hood system can include or be coupled to at least one loudspeaker or other sound emitting device that can provide an audible indication.

In an example, the L1 action can include an L1_{B} action. The L1_{B} action can include a local visual or audio indication at the sensor-enabled range hood system combined with at least one local/remote notification, such as via a personal device (such as a smart phone). The L1_{B} action can additionally or alternatively include a notification that can be transmitted through a network, such as an internet, or a trigger to a fire/safety service, such as via a home security system or otherwise. The L1_{B} action can additionally or alternatively include a trigger of a smoke/fire alert system (for example, First Alert®, or an external speaker, or other light alarm system) inside or outside of the home. First Alert® is a registered trademark of the First Alert Trust.

In an example, an L1 action can include an “L1_{C}” action. In an example, the L1_{C} action can include the one or more actions as described for an L1_{B} action, combined with at least one control action, such as a range or hood control action, such as such as an adjustment of the sensor-enabled range hood system, the cooking appliance, or manual remote control.

As mentioned earlier, the L2 criteria can include an L1 criteria in conjunction with a cooking event determined to be outside of normal parameters (no fire present). The L2 action can include an “L2_{A}” action. The L2_{A} action can include triggering a visual or audio indication at the sensor-enabled range hood system. In an example, the visual or audio indication can be emitted from a hood of the sensor-enabled range hood system.

In an example, an L2 action can include an “L2_{B}” action. The L2_{B} action can include a local visual or audio indication at the sensor-enabled range hood system combined with at least one local/remote notification such as through a personal device (such as a smart phone). In an example, the L2_{B} action can additionally or alternatively include a notification transmitted through the internet or a trigger to a fire/safety service, such as via a home security system or otherwise. In an example, the L2_{B} action can additionally or alternatively include a trigger of a smoke/fire alert system (for example, First Alert®, or an external speaker, or other light alarm system) inside or outside of the home.

In an example, the one or more L3 criteria can include cooktop fire imminent or CO₂ levels approaching unacceptable levels (L3_{A}), or cooktop fire actual or CO concentration level dangerous (L3_{B}). In an example, the one or more L3_{A} criteria can cause an action of the sensor-enabled range hood system that can include one or more control actions as described for L1_{C} such as an adjustment of the sensor-enabled range hood system, the cooking appliance, or manual remote control.

In an example, the L3_{B} action can include one or more actions as described for an L3_{A} action in combination with a remediation action. In an example, the L3_{B} action can include one or more remediation actions such as closing the appliance fuel source, such as can include halting a flow of natural gas to the sensor-enabled range top, turning off the electrical supply to the sensor-enabled range top, initiating an active fire retardant system (such as a chemical or mechanical fire retardant system).

In an example, the L3_{B} action can additionally or alternatively include one or more remediation actions that can include controlling at least one component of the ventilation system. For example, the L3_{B} action can include a remediation action that can include at least one of a control of fan speed operation, control of one or more other fans/ventilation, or the opening or other actuation of a make-up air damper.

In an example, a heat monitoring system can additionally or alternatively be included in the system. For example, the system can include a sensor control system that can include a heat sentry mode. In an example, when a heat sensor detects a specified (e.g., high) level of heat, (e.g., approx. 70° C. at the control board, or at a temperature specified in accordance with a recommendation by the supplier), the heat sentry control system can automatically turn the fan to its highest setting.

The L3_{B} action can additionally or alternatively include a remediation action that can include controlling at least one component of another ventilation system not coupled to the sensor-enabled range hood system. For example, the L3_{B} action can include a remediation action that can include triggering a bathroom fan adjustment (for instance for CO mitigation), a closing of one or more doors/rooms such as for fire control, a control of a cycle air handler to mix/dilute air. In an example, the L3_{B} action can include starting one or more bathroom fans (or other fans in the building) such as to initiate an air exchange within the building. In an example, the L3_{B} action can additionally or alternatively include a remediation action that can include opening one or more make-up air dampers (or other conduits) such as to allow replacement air to flow into the building. In an example, the opening of one or more make-up air dampers (or other conduits) can be combined with starting or adjusting one or more air extraction fans or one or more air handling systems to accelerate air exchange with the building, such as including within a space housing the sensor-enabled range hood.

In an example, the sensor-enabled range hood system can additionally or alternatively include at least one control system that can be coupled to at least one sensor that can monitor an action level and at least one action. In an example, the sensor-enabled range hood system can include at least one control system for controlling and monitoring one or more of various operations of the sensor-enabled range hood. In an example, the user interface can be coupled with at least one monitoring system such as to provide information on at least one functional status of at least one component of the sensor-enabled range hood. In an example, the user interface can be coupled with at least one sensor such as to provide information on the operational status of at least one component of the sensor-enabled range hood system. In an example, the sensor-enabled range hood system can comprise one or more visual indicators that can be included in the user interface such as to communicate to the user the status of one or more components of the sensor-enabled range hood system. In an example, the one or more components of the control system illustrated in FIG. 1 can be coupled to an illumination source or a display forming at least a portion of the user interface. In an example, the sensor-enabled range hood system can include one or more illumination sources. In an example, the one or more illumination sources can be arranged or otherwise configured such as to provide lighting to a range top surface. In an example, the one or more illumination sources can additionally or alternatively be arranged or otherwise configured to provide lighting to an area immediately adjacent to the range top surface. In an example, the one or more illumination sources can additionally or alternatively be arranged or otherwise configured to provide an alert or status to a user. For example, the sensor-enabled range hood system can additionally or alternatively include a user interface with at least one light emitting device (that can for example comprise a light-bulb or incandescent lamp, or a neon-bulb, or a light-emitting diode). In an example, the at least one light emitting device can additionally or alternatively some other visible light emitting device such as can be capable of providing a visual signal to a user of the functional status of one or more components of the sensor-enabled range hood system. In an example, the at least one light emitting device can additionally or alternatively include some other visible light emitting device that can be arranged or otherwise configured to provide a visual signal to a user of the action status of one or more components of the sensor-enabled range hood system.

As shown, the sensor-enabled range hood system can include a plurality of actions levels, such as L1, L2, and L3, one or more of which can include a selected one or a selected plurality of actions, such as described herein, such as where an individual action or plurality of actions can be monitored and controlled by the control system. In an example, any one or more of the actions as described can be monitored and remotely controlled. For example, any one of the actions as described can be monitored and remotely controlled through a remote user interface (for instance, through a remotely positioned computer or laptop or tablet or phone or smartphone, and/or through a web page or other interface). Some embodiments can include a remote upgrade management system. In an example, the control system can include a hardware capability to enable upgradable software, and in an example, the control system comprises upgradeable software. In an example, the upgradeable software can be upgraded remotely (for instance, wirelessly, or via the internet). In an example, the upgradeable software can be upgraded by a user or a service technician. In an example, the upgradeable software can be upgraded to include the latest building code requirements. In an example, the upgradeable software can include the latest building code requirements. In an example, the control system can control the ventilation system such as based at least in part on the upgradeable software that can include the latest building code requirements.

FIG. 3 shows an example of portions of the sensor-enabled range hood system 300, together with portions of an environment in which it can be used. A sensor-enabled range hood 302 can be configured to be located above or near a cooking appliance 304, such as a range top, a cook top, or one or more convection or other ovens. The range hood 302 can include a ventilation system 306, which can include a fluid inlet (e.g., that can be directed toward the cooking appliance), a fluid outlet (e.g., that can be directed locally or additionally or alternatively directed external to the building structure, such as via building ductwork), and a fan or blower. The range hood 302 can include a controller circuit 308, such as can include a microprocessor circuit, a microcontroller circuit, embedded controller or hardware, software, or firmware. The range hood 302 can include one or more sensors, such as shown and described elsewhere herein, such as with respect to FIG. 1. The range hood 302 can optionally include an integrated microwave or other oven 312, such as described elsewhere herein. The range hood 302 can include a graphical or other local user interface 314, such as described elsewhere herein. The range hood can include a wired or wireless communication interface 316, such as described elsewhere herein, which can be communicatively coupled to a cooking appliance interface circuit 318 that can be located at the cooking appliance 304, such as for interfacing with one or more of one or more heating elements 320 of the cooking appliance 304, one or more heat or fuel controllers or regulators 322 of the cooking appliance 304, or one or more sensors 324 of the cooking appliance 304 (e.g., such as an inductive sensor, a flow sensor, or other cooking appliance sensor, such as described elsewhere herein).

The communication interface 316 can be configured to additionally or alternatively communicate, via a wired or wireless medium, directly or indirectly with an ancillary component that can be included in or coupled to the system 300, such as one or more of: a local/remote user interface 326 (such as described elsewhere herein, e.g., a laptop, a smart phone application (“app”), or other device that can potentially be located or moved elsewhere within or outside of the building, such as away from the range hood 302); a network interface 328 (such as described elsewhere herein, e.g., a wireless router, a wired modem, etc., such as for communicating with a local area network, such as a home network, or a wide area network, such as an internet); a home fire alert system 330 (such as described herein, for example, a First Alert® or other such system); or a local/remote home security or home monitoring system 332 or service (such as described herein). In an example, one or more of such ancillary components (e.g., the local/remote user interface 326, the network interface 328, the fire alert system 330, or the security system 332) can communicate directly or indirectly with one or more of the other such ancillary components or with one or more of the communication interface 316 or the cooking appliance interface 318.

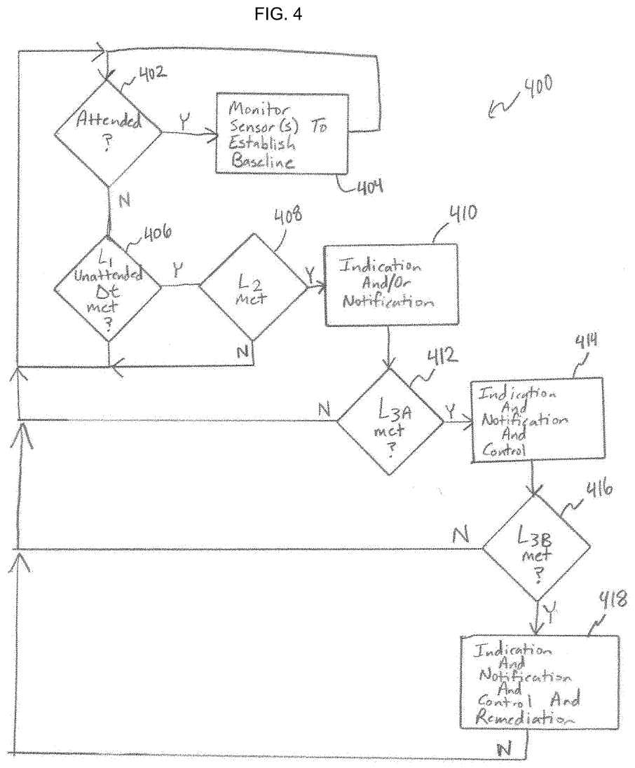

FIG. 4 shows an example of a technique 400, similar to that described with respect to FIG. 2, for using the system 300 to provide a multi-level staged response to varying severity events during unaccompanied cooking, together with a technique for establishing one or more baseline sensor values(s) for use in determining event occurrences.

At 402, when the cooking appliance interface 318 indicates that at least one heating element of the cooking appliance 304 is turned on, such that cooking is underway, the system 300 can determine whether the cooking is attended. If so, then at 404, one or more of the sensors 306 of the range hood or the sensors 324 of the cooking appliance 304 can be monitored during such attended cooking to establish respective baseline values for such sensor(s) that, in an example, can be deemed “within normal cooking parameters” because it is occurring during such attended cooking.

Subsequently, such as during a detected undetected cooking episode, one or more subsequent deviations from normal cooking parameters (e.g., raw difference from baseline, percentage difference from baseline, etc.) that meets a corresponding individual threshold (or a scaled linear combination or other weighted combination of multiple sensor values that meets a corresponding combined threshold) can be used to indicate an abnormal cooking condition, including, for example, an abnormal pre-ignition cooking condition.

At 406, sensor information from a motion detector or other proximity sensor 102 of the sensors 310 associated with the range hood 302 or the sensors 324 associated with the cooking appliance 304 can be used to determine whether a cook or other user is present in the vicinity of the cooking appliance. This can include the controller circuit 308 including a timer circuit that can be started or re-started upon a detected change in occupancy from present to not present. The timer circuit can count the elapsed time since the cook or other user was last determined to be present. The elapsed time can be compared to an unattended time threshold value at 406. If the elapsed time does not exceed the unattended time threshold value, then process flow can return to 402.

At 408, if the elapsed time does exceed an unattended time threshold value at 406, then condition of one or more of the sensors 310, 324 can be tested, either individually or in a specified weighted or other combination. In an example, this can include determining whether an L₂ condition is present, such as described herein, including with respect to FIG. 2. The L₂ condition can indicate an abnormal pre-ignition cooking condition, such as where the controller circuit 308 determines that the specified one or more sensor parameters is outside of a normal range, such as described herein, including with respect to FIG. 2. This L₂ condition can be declared when a specified one or more sensor parameter deviations from one or more corresponding baseline values exceeds a specified raw or percentage difference from its baseline value. If the L₂ condition is met at 408, then a response can be triggered at 410, otherwise process flow can return to 402.

At 410, the response to the L₂ condition that can be triggered can include providing a local Indication (e.g., at the range hood 302 or at the cooking appliance 304), a local/remote Indication (e.g., a Notification via a local/remote user interface 326 or another ancillary device), or both. Then, process flow can continue to 412, as shown, or can return to 402 to recheck whether the cooking has changed from unattended to attended.

At 412, condition of one or more of the sensors 310, 324 can be tested, either individually or in a specified weighted or other combination. The sensors tested at 412 can be the same one or more sensors 310, 324 tested at 408, or a different one or more sensors 310, 324. In an example, this can include determining whether an L_{3A} condition is present, such as described herein, including with respect to FIG. 2. The L_{3A} condition can use one or more different criteria than the L₂ condition, such that the L_{3A} condition can indicate abnormal pre-ignition cooking conditions that are deemed indicative of (1) imminent fire at the cooking appliance 304, (2) unacceptably high CO levels, or both. This L_{3A} condition can be declared when a specified one or more sensor parameter deviations from one or more corresponding baseline values exceeds a specified raw or percentage difference from its baseline value. If the L_{3A} condition is met at 412, then a response can be triggered at 414, otherwise process flow can return to 402.

At 414, the response to the L_{3A} condition that can be triggered can include providing a local Indication (e.g., at the range hood 302 or at the cooking appliance 304), a local/remote Indication (e.g., via a local/remote user interface 326 or another ancillary device), or both. A control signal (“C”) can also be issued, such as to one or both of the range hood 302 or the cooking appliance 304, such as via the communication interface 316 such as to adjust a ventilation parameter (e.g., fan speed, etc.) of the range hood 302, or to reduce, terminate, or otherwise adjust a heat or fuel provided at the cooking appliance 304. The control signal (“C”) can additionally or alternatively be provided to one or more other ventilation, home security, or other same-home device, such via the network interface 328, the fire alert system 330, or the security system 332. Such other same-home devices can include, for example, one or more exhaust fans that can be located away from the cooking appliance, one or more garage door openers, one or more make-up air vents/dampers such as can be associated with the home's HVAC system, etc. For example, if the control signal C is used to increase a fan speed of the range hood 302, than one or more make-up air vents/dampers can be adjusted such as to permit additional make-up air inflow into the home. Then, process flow can continue to 416, as shown, or can return to 402 to recheck whether the cooking has changed from unattended to attended.

At 416, condition of one or more of the sensors 310, 324 can be tested, either individually or in a specified weighted or other combination. The sensors tested at 416 can be the same one or more sensors 310, 324 tested at 408 or 412, or a different one or more sensors 310, 324. In an example, this can include determining whether an L_{3B} condition is present, such as described herein, including with respect to FIG. 2. The L_{3B} condition can use one or more different criteria than the L₂ and L_{3A} condition, such that the L_{3B} condition can indicate abnormal cooking conditions that are deemed indicative of (1) actual fire present at the cooking appliance 304, (2) unacceptably high CO levels, or both. This L_{3B} condition can be declared when a specified one or more sensor parameter deviations from one or more corresponding baseline values exceeds a specified raw or percentage difference from its baseline value. If the L_{3B} condition is met at 416, then a response can be triggered at 418, otherwise process flow can return to 402.

At 418, the response to the L_{3B} condition that can be triggered can include providing a local indication (e.g., at the range hood 302 or at the cooking appliance 304), a local/remote indication (e.g., via a local/remote user interface 326 or another ancillary device), or both. At 418, a control signal (“C”) can additionally or alternatively be issued (such as described herein, including with respect to FIG. 2) such as to one or both of the range hood 302 or the cooking appliance 304, such as to adjust a ventilation parameter (e.g., fan speed, etc.) of the range hood 302, or to reduce, terminate, or otherwise adjust a heat or fuel provided at the cooking appliance 304. The control signal “C” issued at 418 can differ from the control signal “C” issued at 414. As an illustrative example, at 414, the control signal “C” can trigger an increase in fan speed and make-up air vent/damper airflow, while at 418 the control signal “C” can shut off the fan and the make-up air vent/damper airflow. At 418, a remediation signal (“R”) can be provided (such as described herein, including with respect to FIG. 2), such as to shut off the fuel or heat source of the cooking appliance 304, to activate a chemical or mechanical fire retardant system (e.g., a portion of which can be included in the range hood 302 or nearby), control a parameter of the ventilation system 306 (e.g., fan speed), notify a home security monitoring service, such as via the security system 332, or a combination of these remediation responses. Then, process flow can return to 402 to recheck whether the cooking has changed from unattended to attended (as shown) or can return to 416 to continue to monitor whether the L_{3B} condition is still present.

### Further Sensor Technology Examples

Before ignition of a flame, several environmental changes can occur that can be considered as signs that a fire is imminent. These changes can include a change in temperature, humidity, carbon monoxide, carbon dioxide gas concentration, oxygen gas concentration, an increase in the formation of smoke particulates, an increase in the formation of volatile organic compounds (VOCs). A variety of sensors can be used to monitor these environmental characteristics. These are outlined as follows and described further below and elsewhere in this document.

Some examples of the sensors 310, 324 that can be used in the system 300 can include, among others: a VOC sensor; a temperature sensor (e.g., non-optical, optical (e.g., infrared), etc.); a humidity sensor (capacitive, resistive, thermal conductivity, etc.); a smoke sensor (e.g., ionization, photoelectric, etc.); a carbon monoxide (CO) sensor (e.g., biomimetic, electrochemical, semiconductor, etc.); a carbon dioxide (CO₂) sensor (e.g., non-dispersive infrared, chemical, solid-state, etc.); an oxygen sensor (e.g., galvanic, paramagnetic, polarographic, zirconium oxide, etc.); or a motion sensor (e.g., passive, active, etc.).

### VOC Sensors

Numerous organic compounds can be identified in cooking emissions, such as including one or more aldehydes, alcohols, ketones, phenols, alkanes, alkenes, alkanoic acids, carbonyls, PAHs, and aromatic amines The exact compounds emitted and their levels can vary by a number of factors, such as including the type of food or cooking method. For example, a study measuring the type and concentration of volatile organic compounds (VOCs) generated during roasting of pork in an electric oven detected between 61 and 154 different VOCs, depending on the cooking temperature utilized.

In an example, the one or more sensors 306 or the one or more sensors 324 can include one or more VOC sensors, which can be configured to detect multiple substances simultaneously. For example, one sensor can concurrently detect methane, carbon monoxide, natural gas, alcohols, ketones, amines, organic acids, as well hydrocarbon-based substances. Another sensor can concurrently detect carbon monoxide, ethanol, hydrogen, ammonia, and methane. The output from a VOC sensor can be a single value such as can be derived through a sensor-specific technique of combining one or more contributions from an number of contributing gases. A VOC sensor can provide a particular sensor output indicative derived from a large number of possible combinations of gases. Therefore, multiple cooking scenarios can lead to a like sensor output. Therefore, a VOC sensor can be made more useful in combination with another sensor output, such as to help detect an imminent fire from the complex assortment of VOCs that can be emitted during cooking.

Although the technique shown in FIG. 4 has emphasized use of a control signal “C” to the range hood 302, the cooking appliance 304, or another device being made in response to a triggering condition being met, information from one or more of the sensor(s) 310, 324 or the ancillary devices 326, 328, 330, 332 can additionally or alternatively be used to provide a control signal to the range hood 302, the cooking appliance 304, or another device even when the triggering condition is not met. As an illustrative example, information from a particle sensor 112 can additionally or alternatively be used to automatically turn on or adjust the ventilation system 306 of the range hood 302 even when the L_{3A} condition is not met.

Moreover, additional or alternative triggering criteria can be used, such as with the technique of FIG. 4. As an illustrative example, the technique shown in FIG. 4 can itself be initiated or triggered by the detection of a cooking event underway, either via the one or more sensors 324 or via a status signal provided by one or more of the heating element 320, or the heat/fuel control circuit 322, or other signal provided by the cooking appliance 304, such as via the cooking appliance interface 318 or otherwise. Thus, the determination at 402 of whether the cooking is attended can be performed contingently on a determination that cooking is occurring.

### Temperature Sensors

In an example, the one or more sensors 306 or the one or more sensors 324 can include one or more non-optical temperature sensors (e.g., a resistance temperature detector (RTD), a thermocouple, a thermistor, etc.), such as can be used to measure the air temperature over the cooking range top or a particular portion thereof. In an example, the non-optical temperature sensor can include a thermocouple, such as can be used for, among other things, measuring the temperature of the incoming air into the range hood ventilation system 306. This type of sensor may require relatively no maintenance or cleaning with a low occurrence for false alarms. It is also relatively low cost.

In an example, the one or more sensors 306 or the one or more sensors 324 can additionally or alternatively include one or more non-optical temperature sensors, such as an infrared temperature sensor device, which can be located at the range hood 302 and placed in view of the range top or other cooking appliance 304. This type of sensor may be prone to false alarms as the result of high temperature cooking or external infrared signals. Additional cleaning of the sensor may be needed and some replacement or maintenance may be needed.

In an example, the range hood 302 can include at least one of a thermocouple or a thermistor, such as can be arranged or otherwise configured to measure the temperature of the air over the cooktop, together with an infrared temperature sensor, which can be arranged or otherwise for measurement of the temperature of the cooktop of the cooking appliance 304 such as from a location at the range hood 302. To improve the accuracy of the cooktop temperature data collected, the infrared sensor's field of view can be limited, such as to less than an angle value that can be between 5 degrees and 10 degrees.

### Humidity Sensors

In an example, the one or more sensors 306 at the range hood 302 or the one or more sensors 324 at the cooking appliance can include one or more humidity sensors, such as can include one or more of a capacitive humidity sensor, a resistive humidity sensor, or a thermal conductivity humidity sensor. In an example, the capacitive humidity sensor can include a substrate on which a thin film of polymer or metal oxide has been deposited between two conductive electrodes. The sensing surface can be coated with a porous metal electrode, such as to protect it from contamination or condensation. A capacitive humidity sensor can function at high temperatures, can exhibit full recovery from condensation, and can provide reasonable resistance to chemical vapors. A resistive humidity sensor can measure the change in electrical impedance of a medium, such as a hygroscopic medium, such as a conductive polymer, salt, or treated substrate. A resistive humidity sensor can exhibit a temperature dependency, and therefore can benefit from temperature compensation by a temperature sensor that can be included in the system 300 and located at or near the resistive humidity sensor, such as at the range hood 302. A thermal conductivity humidity sensor can be arranged or otherwise configured to measure absolute humidity, such as by quantifying a difference between a thermal conductivity of dry air and that of air containing water vapor. An absolute humidity sensor can provide a greater resolution humidity measurement at temperatures exceeding 93° C. than capacitive or resistive humidity sensors, and may be used in a harsher environment where a capacitive or resistive humidity sensor may not survive. A thermal conductivity humidity sensor can perform well in a corrosive environment and at a high temperature.

### Smoke Sensors

In an example, the one or more sensors 306 at the range hood 302 or the one or more sensors 324 at the cooking appliance can include one or more smoke sensors, such as can include one or more of an ionization smoke sensor, a photoelectric smoke sensor, or the like. The ionization smoke sensor can include a small amount of radioactive material between two electrically charged plates, which ionizes the air and results in current flow between the plates. When smoke enters the chamber it disrupts the flow of ions, thus reducing the flow of current and triggering a responsive alert or other action. However, cooking particles entering the ionization chamber can also attach themselves to the ions and cause a reduction in electric current, thereby potentially resulting in a false alarm. The photoelectric smoke sensor can focus a light source into a sensing chamber, such as at an angle away from the sensor. When smoke enters the chamber, it can reflect light onto the light sensor. It is possible for cooking particles to enter the photo chamber and cause the light to scatter onto the photocell triggering a false alarm, but with less likelihood than an ionization-type smoke detector near (e.g., at a distance of 3 feet) the cooking appliance).

### Carbon Monoxide Sensors

In an example, the one or more sensors 306 at the range hood 302 or the one or more sensors 324 at the cooking appliance can include one or more carbon monoxide (CO) sensors, such as can include one or more of a biomimetric CO sensor, an electrochemical CO sensor, or a semiconductor CO sensor. The biomimetric CO sensor can use a gel coated disc that can change color or darken in the presence of carbon monoxide, such as proportional to the amount of carbon monoxide in the surrounding environment. A color recognition sensor can be included and configured to recognize a specified color change and, when detected, can trigger an alert or other response. The electrochemical CO sensor can include a type of a fuel cell that can be configured to produce a current that can be relatively precisely related to the amount of the carbon monoxide in the surrounding environment. Measurement of the current gives a measure of the concentration of carbon monoxide in surrounding environment, a specified change in which, when detected, can trigger an alert or other response. The semiconductor CO detector can include an electrically powered sensing element that can be monitored by an integrated circuit, such as the controller circuit 308. The CO sensing element can include a thin layer of tin dioxide that can be placed over a ceramic. Oxygen can increase the electrical resistance of the tin dioxide while carbon monoxide can reduce the electrical resistance of tin dioxide. The integrated circuit monitors the resistance of the sensing element, and a specified change in resistance corresponding to a specified change in CO can be used to trigger an alert or other response. Electrochemical carbon monoxide sensors, which are chemically resistant, stable during temperature and humidity fluctuations, and have fast response times, are believed most suitable to the present range hood system.

### Carbon Dioxide Sensors

In an example, the one or more sensors 306 at the range hood 302 or the one or more sensors 324 at the cooking appliance can include one or more carbon dioxide (CO₂) sensors, such as can include one or more of a non-dispersive infrared CO₂ sensor, a chemical CO₂ sensor, or a solid-state CO₂ sensor. The non-dispersive infrared (NDIR) CO₂ sensor can include a spectroscopic sensor that can detect carbon dioxide in a gaseous environment such as by its characteristic absorption. The gas can enter a light tube and accompanying electronics can be used to measure the absorption of the wavelength of the light. The chemical CO₂ sensor can measure a pH change in an electrolyte solution caused by the hydrolysis of carbon dioxide, but can experience both short and long term drift effects as well as a low overall usable lifetime compared to NDIR CO₂ sensor technology. The solid state CO₂ sensor can include a potentiometric measuring of CO₂ using a silver halide solid state electrolyte, but with less accuracy compared to NDIR CO₂ sensor technology.

### Oxygen Sensors

In an example, the one or more sensors 306 at the range hood 302 or the one or more sensors 324 at the cooking appliance can include one or more oxygen sensors, such as can include one or more of a galvanic oxygen sensor, a paramagnetic oxygen sensor, a polarographic oxygen sensor, or a zirconium oxide oxygen sensor. The galvanic oxygen sensor, also referred to as an ambient temperature electrochemical sensor, can include two dissimilar electrodes that can be immersed in an aqueous electrolyte. These sensors can exhibit a limited lifetime, which can be reduced by exposure to high concentrations of oxygen. The paramagnetic oxygen sensor can use oxygen's relatively high magnetic susceptibility to determine oxygen concentration. The paramagnetic oxygen sensor can have a good response time, sensor life, and precision over a range of 1% to 100%, but are not recommended for trace oxygen measurements. Contamination of these sensors, such as by dust, dirt, corrosives or solvents can lead to deterioration. The polarographic oxygen sensor can include an anode and cathode that can be immersed in an aqueous electrolyte. The zirconium oxide oxygen sensor can include a solid state electrolyte that can be fabricated from zirconium oxide. These sensors demonstrate excellent response time characteristics, but are not recommended for trace oxygen measurements when reducing gases, including carbon monoxide, are present. For zirconium sensors the sample gas should be heated to the zirconium sensor's operating temperature of approximately 650° C., which may be impractical. Accordingly, a galvanic oxygen sensor, which is CO, CO₂, and vibration resistant, is believed to be the best choice for inclusion in the present system 300.

### Motion Sensors

In an example, the one or more sensors 306 at the range hood 302 or the one or more sensors 324 at the cooking appliance can include one or more passive or active motion or other user proximity sensors, which can provide information about unattended cooking that can have a substantial impact on mitigating cooking fires, as the absence of a cook can be a primary factor contributing to ignition of home cooking fires. The motion sensor can be configured to detect the absence or presence of cook or other user. A motion sensors can have an impact on the behavior of the cook if used to treat unattended cooking as an indication for potential flaming ignition. The passive motion sensor can include an infrared detector to detect differences in heat. A passive motion sensor is expected to provide about a 10 year useful life, but does not have a very wide field of view, and may be susceptible to grease buildup. An active motion sensor can use microwave, ultrasonic, or radio frequency energy to detect motion. Ultrasonic systems can be affected by the build-up of grease or oil on the sensor surface. Microwave and radio frequency sensors are not significantly affected by the presence of grease on their surfaces. Active motion sensors are expected to provide about a 10 year useful life.

Both active and passive motion sensors have the potential for false actuation, such as from a large pet or child, which could trigger the motion sensor even if no one was attending to the cooking process.

### Sound/Microphone

In an example, the one or more sensors 306 at the range hood 302 or the one or more sensors 324 at the cooking appliance can include a microphone, such as to monitor the sound environment in the cooking area. The frequency profiles of various events can be detected and used in the sensor algorithm. For instance, specific cooking events (e.g., frying, boiling, etc.), the presence of fire, or even human presence can have a particular frequency profile that can be recognized and distinguished from other such events, and the information used alone or together with other information to trigger a response.

### Critical Distance Sensor

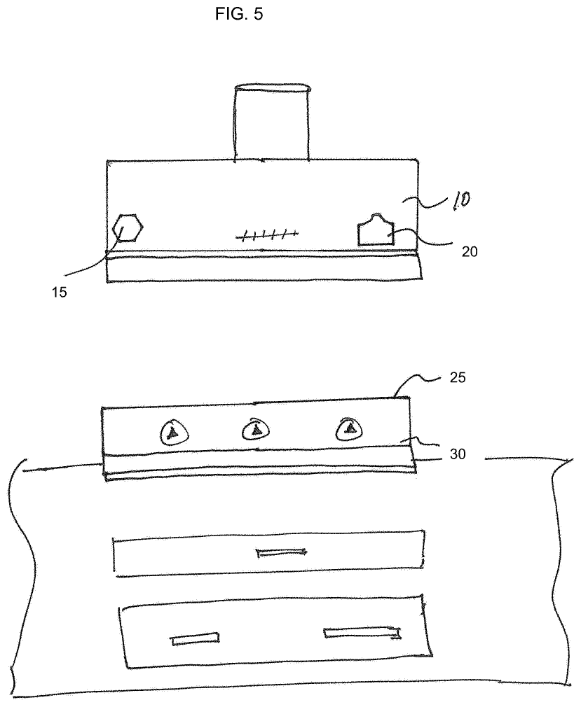

The sensor-enabled range hood system can additionally or alternatively include a distance sensor assembly. According to one embodiment of the present disclosure, and as shown in FIG. 5, a range hood 10 includes a distance sensor assembly 15 that automatically determines the distance between the distance sensor assembly 15 and an associated cooking surface 25—i.e., the “critical distance.” The cooking surface 25 can be defined by a flat surface that overlays at least one burner, or by collection of grates that overlays at least one burner. In the embodiment of FIG. 5, the critical distance is the vertical distance between the distance sensor assembly 15 in the hood 10 and the cooking surface 25. In FIG. 5, a cook top 30 is shown installed in a counter-top above drawings, as commonly found in a kitchen.

Once determined, the critical distance may be used in any of a number of ways to calibrate the one or more of the sensors mentioned above (hereinafter referenced as “fire sensor module”). For example, the critical distance can be used to adjust the sensitivity level in a monitoring and alerting algorithm used by a fire sensor module 20 in the hood 10, adjust the output of that algorithm or otherwise modify the process of sensing any of the various characteristics sensed by the fire sensor module 20 to account for the critical distance. This adjustment eliminates the need of having an installer or the end-user (e.g.,. homeowner, chef, etc.) manually measure the critical distance and then manually input an indicator of that critical distance into the monitoring and alerting algorithm, either directly or through an interface that interacts with the algorithm. To ensure that the first sensor module 20 has accurate information, the critical distance is continually monitored by the distance sensor assembly 15 for any changes thereto, including detection of obstructions placed on the cooking surface 15, or other changes on the cooking surface 25 that may impact the monitoring accuracy.

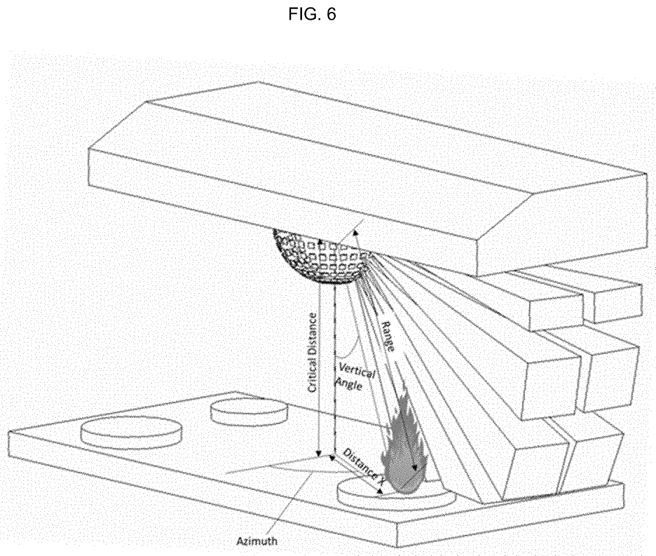

In one embodiment, the fire sensor module 20 employs an array of energy receptors. Within the fire sensor module 20, each receptor is positioned with or without the assistance of a separating device (e.g. Fresnel lens), such that the energy reaching the receptor is primarily from sources within a specific volume in space. This volume in space for a given receptor is called receptor volume (Ai. Vi), were Ai is the azimuth angle and Vi is the vertical angle for a specific receptor. See FIG. 6. The arrangement of the receptors, each with a fixed azimuth and vertical angle, within the array determines which volumes in space can be monitored by the fire sensor module 20. The amount of energy per area, from a source that reaches a receptor is reduced by distance and obstructions between the source and the receptor. The converse of this is also true.

By evaluating the intensity at multiple receptors, the receptor volume (j) containing a heat source can be identified. Because the orientation and location of the receptor, and the critical distance, are known the actual distance to the heat source can be calculated. The sensitivity distance (j) is used to determine heat source temperature based upon the intensity. Further since distance “X” can also be calculated, the intensity at adjacent receptors can be used to determine the height, base size, and temperature range of the heat source. This data is used to improve the accuracy of the flame sensor module 20.

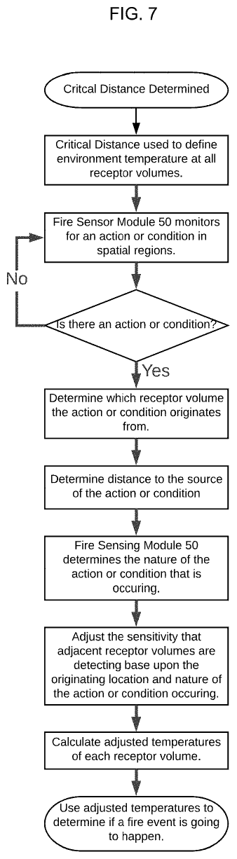

The flow chart provided in FIG. 7 shows one exemplary process for improving the accuracy of the fire sensor module 20. In particular, the process of FIG. 7 uses the critical distance obtained by the distance sensor assembly 15 to define the environmental temperature at all of the receptor volumes in the array of energy receptors of the fire sensor module 20. The fire sensor module 20 then monitors of the monitored environment (e.g. cooking surface 25) for actions or conditions in the various spatial regions monitored by the array of energy receptors. If an action or condition is sensed, the sensor module 20 then determines the receptor volume in which the action or condition was sensed and then uses the distance to that action or condition. The fire sensing module 20 then determines the nature of the action or condition sensed and adjusts the sensitivity for adjacent receptor volumes based upon the originating location and nature of the action or condition sensed. The fire sensor module 20 then calculates an adjusted (i.e. calibrated) temperature of each receptor in the array and then uses that adjusted temperature to determine whether or not that adjusted temperature (either alone or in conjunction with other sensed properties) is indicative of a fire or possibility of a future fire.

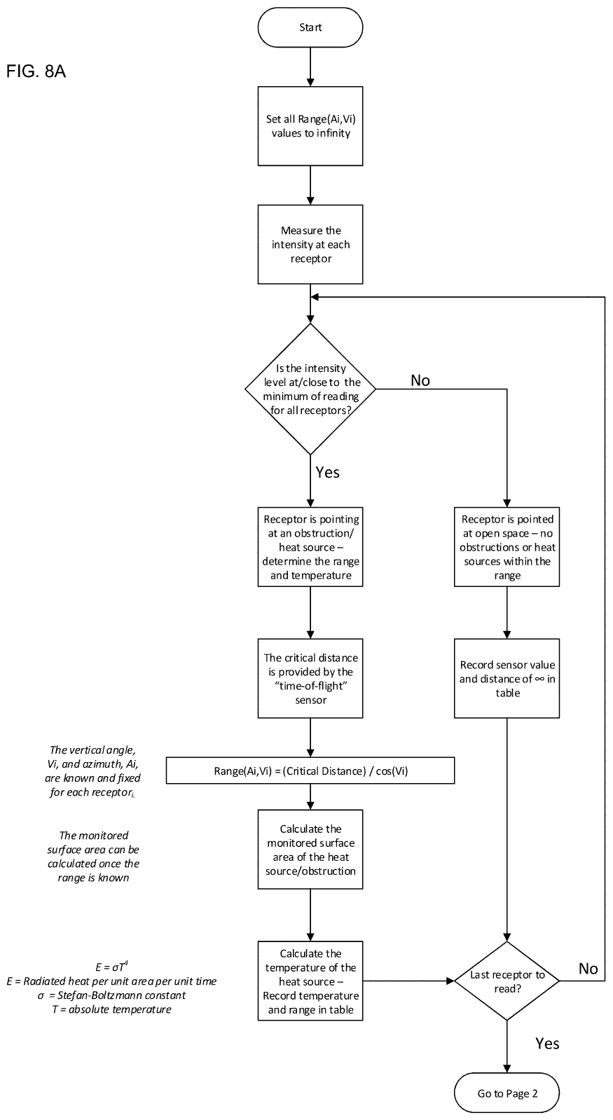

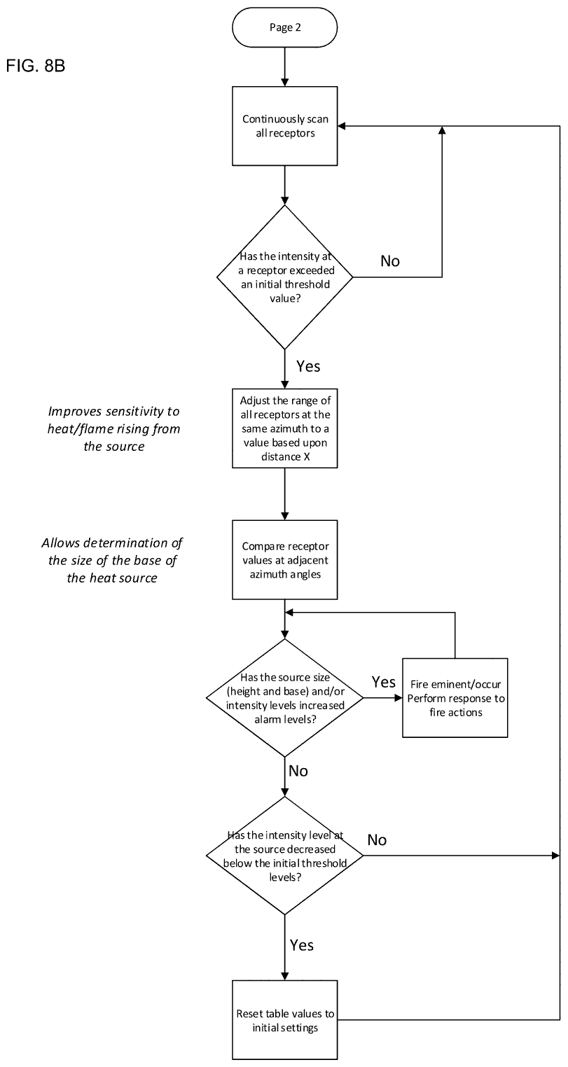

The flow chart in FIGS. 8A-8B shows another exemplary process for improving the accuracy of the fire sensor module 20. In particular, the process of FIG. 8A first sets all values Ai, Vi to infinity and then measures the intensity at each energy receptor in the array. Any energy receptor that provides an intensity reading at or close to the minimum possible for the energy receptors is considered to be pointed at open space without any obstruction or heat source (e.g. not pointed at the cooking surface 25) and both the value and distance for that energy receptor is recorded at infinity. Any energy receptor that provides an intensity reading materially above the minimum possible for the energy receptors is considered to be pointed at an obstruction or hear source (e.g. pointed at the cooking surface 25) and the so (a) the range and temperatures are determined, (b) the critical distance is determined by the distance sensor assembly 15 or a previous critical distance measurement can be accessed from memory, (c) the Range (Ai, Vi) is calculated as the critical distance times the cosine of the angle at which the energy receptor is angled from vertical, (d) the surface area of the monitored energy receptors (i.e. those not set to infinity) is then calculated (e.g. the monitored area of the cooking surface 25), and (e) the calibrated temperature of the surface is then recorded. This process is repeated until all of the energy receptors have been measured.

Next, as shown in FIG. 8B, intensity measurements are constantly then taken from each energy receptor and each measurement is checked to determine whether or not it has exceeded an initial threshold value. If not, then the taking of intensity measurements continues uninterrupted. If, however, the initial threshold value has been exceeded, then, the range of the each energy receptor at the same azimuth can be adjusted to a value based on the distance X. The receptor measurement can then be compared to the measurement of an adjacent receptors. If the alarm levels then increase, a fire is likely imminent and corrective actions (e.g. terminating power, releasing fire suppression materials) can be triggered. If the intensity measurement has decreased below the initial threshold value, then the system returns to constantly taking intensity measurements from each energy receptor and checking to determine whether or not each measurement exceeds the initial threshold value.

The distance sensor assembly 15 and the fire sensor module 20 can be two separate components, or a single component package, both configured to be integrated with the hood 10. It should be understood that if the distance sensor assembly 15 and the fire sensor module 20 are two separate components and are located at different heights within the hood 10, this difference in height can be preprogramed into the distance sensor assembly 15 or the distance sensor assembly 15 may use a second horizontal sensor that measures this height difference between the height of the distance sensor assembly 15 and the fire sensor module 20. This height differential can then be accounted for by the distance sensor assembly 15 and the accurate height of the fire sensor module 20 can be determined and utilized by the monitoring and alerting algorithm.

The distance sensor assembly 15 can make the determination of the critical distance during an initialization step or process initiated by the installer or end-user after the hood 10 is installed in the desired position and at the desired height above the cooking surface 25. In one embodiment, the distance sensor assembly 15 can employ a Time-of-Flight (ToF) laser-ranging sensor module, such as the ST Micro VL53L0X sensor, to determine the critical distance. This type of sensor provides accurate distance measurements and is not affected by any reflections from the target (e.g., the cooking surface 25). It should be understood that other types of distance sensors may be used, such as other optical sensors, radar sensors, sonar sensors, electromagnetic, or ultrasonic sensors.

Compared to conventional devices, the determination of the critical distance by the distance sensor assembly 15 ensures that the sensitivity levels employed by the alerting algorithm in the fire sensor module 20 are accurate, thereby improving the ability of the fire sensor module 20 to accurately monitor the cooking surface and determine cooking conditions that warrant an alert. As such, the hood 10 will not erroneously alarm and/or signal the cooking surface 25 to shut off, either too early (which creates a nuisance situation requiring the end-user to re-start the cooking surface 25), or too late (which can increase the risk of a fire on the cooking surface 25).

According to another embodiment, the hood 10 includes a fully integrated, enhanced fire sensor module 20, meaning that it can be used to control operation of the components of the hood 10, for example the hood's ventilation fan and/or light settings. Also, the fire sensor module 20 can be used in combination with additional sensors located in or around the hood 10, such as sensors that detect elevated particulate matter (pm 2.5), volatile organic compounds (VOCs), and carbon monoxide. In this manner, the fire sensor module 20 monitors for and determines a high heat/potential fire situation, as well as automatically operating the fan and/or lights of the hood 10. Depending on the output of the sensor module 20, the fan could be automatically cycled on to a speed setting that would provide the required capture of the cooking plume. This would provide the end-user with the convenience of hands-free operation of their hood 10, while ensuring that the hood 10 is providing ventilation at the proper rate to capture the cooking plume, while neither over-ventilating or under-ventilating for the monitored conditions of the cooking surface 25 and the cook top 30. It should be understood that the critical distance may also be utilized by these additional sensors to help ensure they are properly calibrated to the installation environment.

According to another embodiment, the hood 10, including the fire sensor module 20, could include a wireless module that interfaces with a cloud environment and/or the internet. Most of the commercially available range hood fire sensors are closed systems and just react by locally warning and locally shutting off the fuel source. By coupling the fire sensor module 20 wirelessly to the internet, the value and versatility of the hood 10 is improved as the fire sensor module 20 can be updated as needed, diagnostics and servicing can be identified, and cooking habits can be reviewed and improved by the end-user.

According to another embodiment, the hood 10, including the fire sensor module 20, could include a wireless module that interfaces with a wireless sensor assembly. The wireless sensor assembly may be portable and need not be permanently affixed to the hood 10. The wireless sensor assembly also is similar to the distance sensor assembly 15, but it includes a wireless radio that can communicate wirelessly with the fire sensor module 20. The wireless sensor module can determine its relative position in comparison to the fire sensor module 20 and it can determine the distance the wireless sensor module is positioned above the cooking surface 25. The wireless sensor assembly can then accurately inform the fire sensor module 20 of its location above the cooking surface 25. This distance can then be utilized by the algorithm contained within the fire sensor module 20 to adjust or calibrate the fire sensor module 20, as described above.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects. It is intended by the following claims to claim any and all applications, modifications and variations that fall within the true scope of the present teachings. Other implementations are also contemplated.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

What is claimed is:

1. A sensor-enabled range hood for positioning over a cooking surface, the sensor-enabled range hood comprising:
a hood body;
a fire sensor module configured to be connected to the hood body;
a distance sensor assembly in communication with the fire sensor module, the distance sensor assembly configured to determine a critical distance between the hood body and the cooking surface;
wherein the critical distance facilitates accurate monitoring of the cooking surface by the fire sensor module.

2. The sensor-enabled hood of claim 1, wherein the distance sensor is positioned within the hood body.

3. The sensor-enabled hood of claim 1, wherein the fire sensor module is positioned within the hood body.

4. The sensor-enabled hood of claim 1, wherein the distance sensor assembly and the fire sensor module are configured to be different distances from the cooking surface.

5. The sensor-enabled hood of claim 1, wherein the fire sensor module and the distance sensor assembly are in a single package.

6. The sensor-enabled hood of claim 1, wherein the fire sensor module is operated in association with a monitoring and alerting algorithm and the critical distance is used by the monitoring and alerting algorithm to increase accuracy of the monitoring of the cooking surface by the fire sensor module.

7. The sensor-enabled hood of claim 6, wherein the monitoring and alerting algorithm is resident on the fire sensor module.

8. The sensor-enabled hood of claim 6, wherein the monitoring and alerting algorithm is resident on the cloud.

9. The sensor-enabled hood of claim 1, wherein the distance sensor assembly comprises a laser-ranging sensor module.

10. A sensor-enabled hood system comprising:
a hood body;
a fire-senor module configured to be associated with the hood body;
a distance sensor assembly configured to be in communication with the fire-sensor module, the distance sensor assembly capable of determining a critical distance between the hood body and an associated cooking surface.

11. The sensor-enabled hood system of claim 10, wherein the distance sensor assembly comprises a laser-ranging sensor module.

12. The sensor-enabled hood system of claim 10, wherein a sensitivity level of the fire-sensor module is configured to be adjusted according to the critical distance.

13. The sensor-enabled hood system of claim 10, wherein the fire-sensor module is configured to be calibrated according to the critical distance.

14. The sensor-enabled hood system of claim 10, wherein the fire sensor module and the distance sensor assembly are in a single package.

15. A sensor system for a range hood, the sensor system comprising:
a fire-sensor module;
a distance sensor assembly configured to be in communication with the fire-sensor module, the distance sensor assembly capable of determining a critical distance between the distance sensor assembly and an associated cooking surface.

16. The sensor system of claim 15, wherein the distance sensor assembly comprises a laser-ranging sensor module.

17. The sensor system of claim 15, wherein a sensitivity level of the fire-sensor module is configured to be adjusted according to the critical distance.

18. The sensor system of claim 15, wherein the fire-sensor module is configured to be calibrated according to the critical distance.

19. The sensor system of claim 15, wherein the fire sensor module and the distance sensor assembly are in a single package.

20. A method comprising the steps of:
(i) providing a fire-sensor module;
(ii) providing a distance sensor assembly configured to be in communication with the fire-sensor module;
(iii) determining a critical distance between the distance sensor assembly and an associated surface; and
(iv) providing the critical distance to the fire-sensor module.
